(19) United States
(12) Patent Application Publication
(10) Pub. No.: US 2014/0014282 A1
(43) Pub. Date: Jan. 16, 2014

(54) SUNSHADE DEVICE

(71) Applicant: MACAUTO INDUSTRIAL CO., LTD., Tainan City (TW)

(72) Inventor: Paul Lin, Tainan City (TW)

(73) Assignee: Macauto Industrial Co., Ltd., Tainan City (TW)

(21) Appl. No.: 13/760,513

(22) Filed: Feb. 6, 2013

(30) Foreign Application Priority Data
Jul. 10, 2012 (TW) 101213289

(51) Int. Cl. E06B 9/24

(52) U.S. Cl. CPC E06B 9/24
USPC 160/368.1

(57) ABSTRACT

A sunshade device for a side window of a vehicle includes a sunshade cloth having two opposite side portions and a pair of non-metallic stretchable support elements that are respectively provided on the two opposite side portions. The non-metallic stretchable support elements are resilient stitch lines that are made of nylon and that are sewn on the two opposite side portions in a plain sewing manner.

### CROSS-REFERENCE TO RELATED APPLICATION

This application claims priority of Taiwanese Application no. 101213289, filed on Jul. 10, 2012.

### BACKGROUND OF THE INVENTION

1. Field of the Invention

This invention relates to a sunshade device, more particularly to a sunshade device with non-metallic stretchable support elements.

2. Description of the Related Art

FIGS. 1 and 2 show a conventional sunshade assembly for a side window of a vehicle. The sunshade assembly includes a sunshade cloth 1 that has a first portion 11 connected to a winding shaft 21, a second portion 12 opposite to the first portion 11, and two opposite side portions 13 which extend between the first and second portions 11, 12. Each of the side portions 13 has a first part 131 and a folded-back second part 132 which is stitched to the first part 131 through a sewing thread 14 such that the first part 131 and the second part 132 form a space 130 therebetween for receiving a steel wire 10. Each of the side portions 13 together with a corresponding steel wire 10 are received in a guide rail 22. The sunshade cloth 1 can be wound in a wound state and can be stretched in an expanded state.

The steel wire 10 is able to expand and stretch the cloth 1 in the expanded state. However, during manufacturing of the side portions 13, the sunshade cloth 1 has to be folded followed by stitching the first part 131 and the folded-back second part 132. Then, the steel wire 10 is inserted into the space 130 of the sunshade cloth 1. These steps would make the method for manufacturing the sunshade assembly complicated and time-consuming.

FIG. 3 illustrates another conventional sunshade assembly having a sunshade cloth 1′ and a pair of steel wires 10′. The steel wires 10′ are attached to the sunshade cloth 1′ using stitch lines 14′ that are sewn on the sunshade cloth 1′ in a zigzag sewing manner. The zigzag sewing manner is still time-consuming.

### SUMMARY OF THE INVENTION

Therefore, an object of this invention is to provide a sunshade device that does not have steel wires attached to a sunshade cloth thereof.

According to an aspect of this invention, there is provided a sunshade device including a sunshade cloth having two opposite side portions, and a pair of non-metallic stretchable support elements that are respectively provided on the two opposite side portions.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional sunshade assembly;

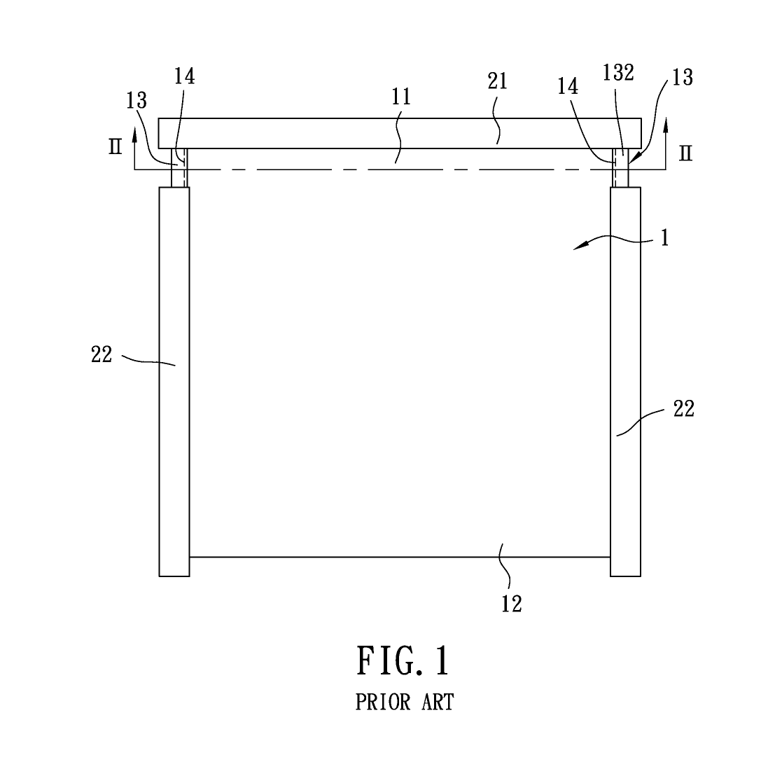

FIG. 2 is a cross-sectional view of the conventional sunshade assembly shown in FIG. 1;

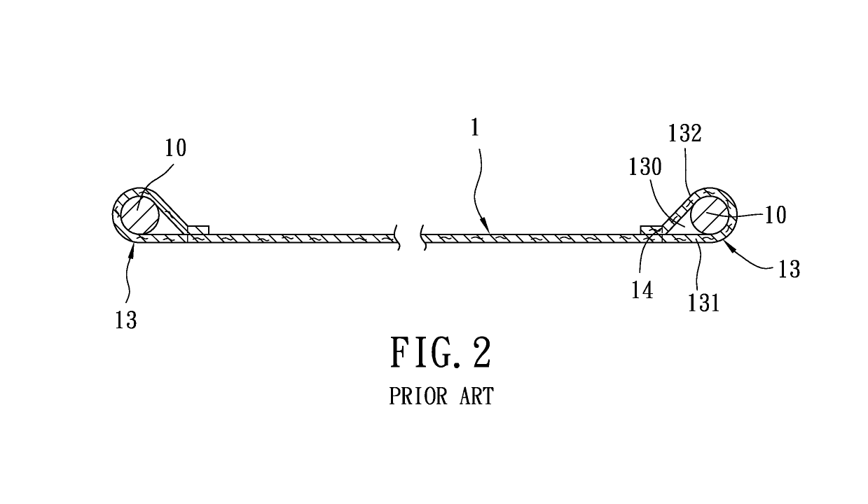

FIG. 3 shows another conventional sunshade assembly;

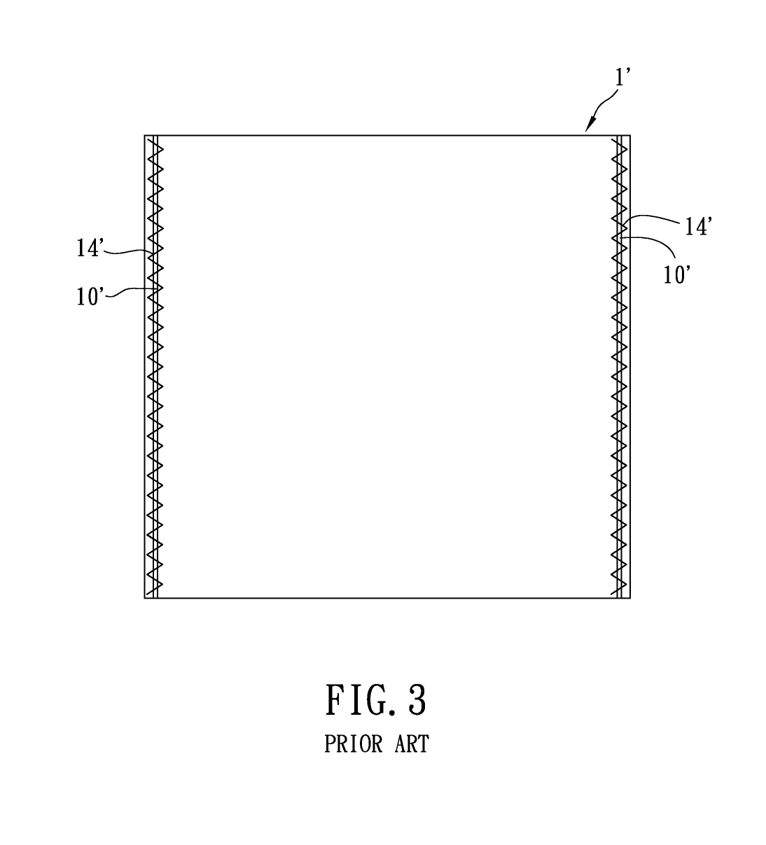

FIG. 4 illustrates the preferred embodiment of a sunshade device according to this invention;

FIG. 5 illustrates a sunshade cloth and a pair of non-metallic stretchable support elements of the preferred embodiment according to this invention; and

FIG. 6 is a cross-sectional view showing the sewing manner of the non-metallic stretchable support elements sewn on the sunshade cloth of the preferred embodiment according to this invention.

### DETAILED DESCRIPTION OF THE PREFERRED EMBODIMENT

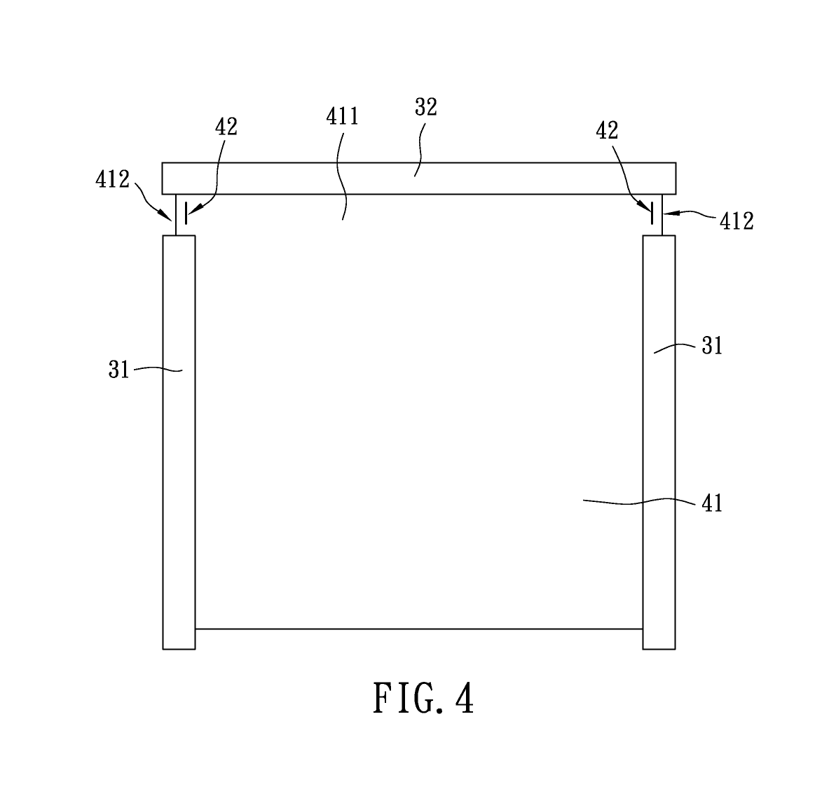

FIGS. 4, 5, and 6 illustrate the preferred embodiment of a sunshade device according to this invention. The sunshade device includes a sunshade cloth 41, a pair of non-metallic stretchable support elements 42, a pair of guide rails 31, and a winding shaft 32. The sunshade cloth 41 has two opposite side portions 412 and a mounting portion 411 wound around the winding shaft 32. The non-metallic stretchable support elements 42 are respectively provided on the two opposite side portions 412. Each of the side portions 412 together with a corresponding one of the non-metallic stretchable support elements 42 is received in a corresponding guide rail 31. The sunshade cloth 41 is movable along the guide rails 31 between an expanded state and a wound state and can be wound on the winding shaft 32.

In this embodiment, the non-metallic stretchable support elements 42 are resilient stitch lines. The resilient stitch lines can be made of, e.g., nylon. The resilient stitch lines have sufficient strength to retain the sunshade cloth 41 in the expanded state, and can be wound along with the sunshade cloth 41 in the wound state.

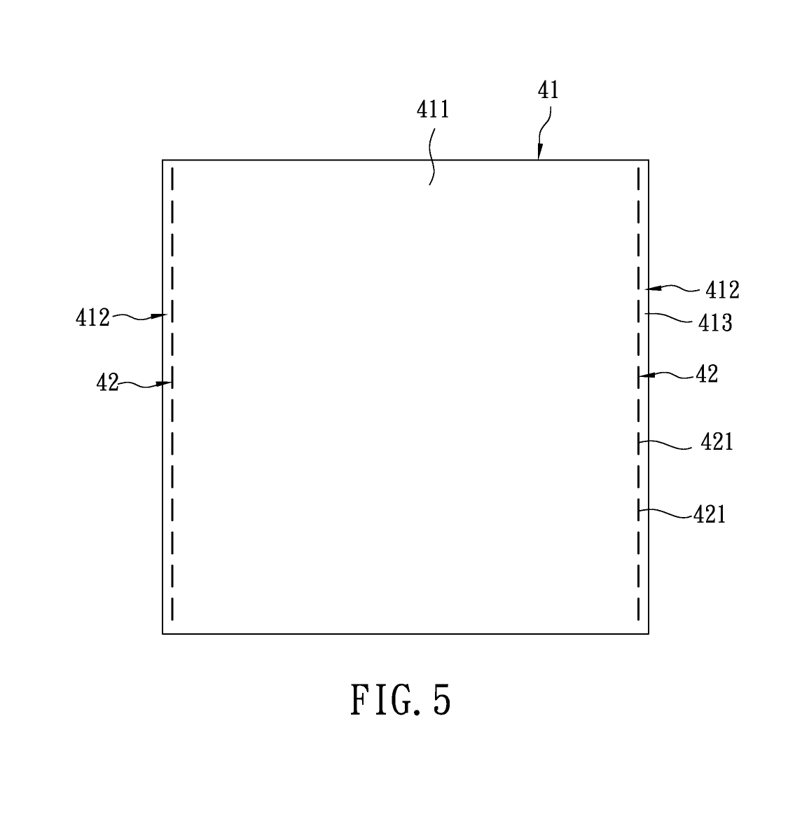

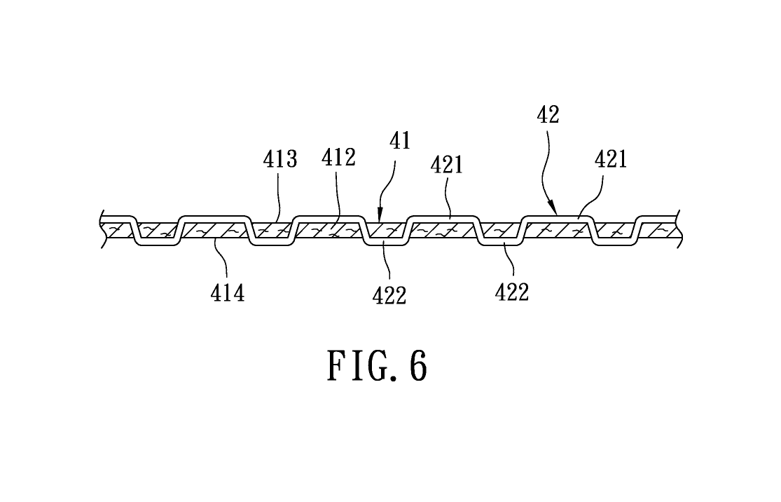

Referring to FIGS. 5 and 6, each of the side portions 412 of the sunshade cloth 41 has opposite first and second surfaces 413, 414. In this embodiment, the resilient stitch lines of the non-metallic stretchable support elements 42 are respectively sewn on the side portions 412 of the sunshade cloth 41 in a plain sewing manner. To be specific, each of the resilient stitch lines has a plurality of first segments 421 spaced apart from one another and disposed on the first surface 413, and a plurality of second segments 422 spaced apart from one another and disposed on the second surface 414. A length of each of the first and second segments 421, 422 is preferably less than 20 millimeters.

During manufacture of the sunshade device of this invention, the non-metallic stretchable support elements 42, e.g., resilient stitch lines, are directly sewn on the side portions 412 of the sunshade cloth 41. The non-metallic stretchable support elements 42 have sufficient strength to stretch the sunshade cloth 41 in the expanded state. The sunshade device of this invention can be manufactured without using steel wires, which is time-saving and economical. Also, the sunshade device of this invention in the wound state has a relatively small volume compared to the conventional sunshade assembly with steel wires attached to a sunshade cloth thereof.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade device, comprising:
a sunshade cloth having two opposite side portions; and
a pair of non-metallic stretchable support elements that are respectively provided on said two opposite side portions.

2. The sunshade device as claimed in claim 1, wherein said stretchable support elements are resilient stitch lines.

3. The sunshade device as claimed in claim 2, wherein said resilient stitch lines are made of nylon.

4. The sunshade device as claimed in claim 2, wherein said resilient stitches are sewn on said two opposite side portions in a plain sewing manner.
